(19) United States
(12) Patent Application Publication
(10) Pub. No.: US 2026/0310173 A1
(43) Pub. Date: Oct. 8, 2026

(54) CONTROL PROGRAM, CONTROL SYSTEM, AND CONTROL METHOD FOR MULTIPLEXED SYSTEM

(71) Applicant: MITSUBISHI HEAVY INDUSTRIES, LTD., Tokyo (JP)

(72) Inventors: Minoru NAKAIDE, Tokyo (JP); Shinichi TODA, Kanagawa (JP)

(21) Appl. No.: 19/478,627

(22) PCT Filed: Feb. 1, 2024
(86) PCT No.: PCT/JP2024/003352

§ 371 Date: Oct. 24, 2025

(30) Foreign Application Priority Data
May 30, 2023 (JP) 2023-088710

(51) Int. Cl. G05B 19/4155; G06F 8/30

(52) U.S. Cl. CPC G05B 19/4155; G06F 8/31

(57) ABSTRACT

The present application relates to a control program for a multiplexed system including control logic for controlling a first execution environment and a second execution environment that are multiplexed. This control program is executed on a computer device to call a user-defined library function from an operation element constituting control logic, and to retrieve an intermediate operation value of the user-defined library function in the standby side execution environment from an interface area that pre-stores an intermediate operation value of the user-defined library function in the active side execution environment.

### TECHNICAL FIELD

The present disclosure relates to a control program, a control system, and a control method for a multiplexed system.

The present application claims the benefit of priority based on Japanese Patent Application No. 2023-088710 filed in the Japanese Patent Office on May 30, 2023, the content of which is incorporated herein by reference.

### BACKGROUND ART

For example, in a control system (for example, PTL 1) for controlling a configuration device in a power generation plant or the like, various controls are realized by installing a control logic prepared for each device as a control target or each function to be realized in an execution environment such as a controller.

### CITATION LIST

### Patent Literature

[PTL 1] Japanese Unexamined Patent Application Publication No. 2004-199658

### SUMMARY OF INVENTION

### Technical Problem

In a control system for a plant facility including a large number of configuration devices, as a control target, identical execution environments are prepared on an operation side and a standby side in a multiplexed manner, and in a case where any abnormality occurs in the execution environment on the operation side, the execution environments on the operation side and the standby side are switched with each other to improve reliability of the system. In such a multiplexed system, in order to prevent a control state from suddenly changing when switching the execution environment between the operation side and the standby side, so-called data tracking in which the control state on the operation side is transferred to the standby side is required.

Meanwhile, as a method for constructing a control logic used in a plant facility, for example, a method using a so-called model-based design (MBD) tool that uses a development environment based on a control model is known. The MBD tool is one of the de facto standard tools for describing the control model, and examples thereof include MATLAB (registered trademark), Simulink, or the like. In these MBD tools, it is also possible to automatically generate a source code corresponding to a created control model using a general-purpose programming language as a standard function or a plug-in function.

In the development environment using such an MBD tool, when trying to construct the control logic for the multiplexed system described above, various types of data that are a target of data tracking exchanged between the multiplexed execution environments can be handled as global variables (including static variables) applicable to the execution environments. However, when all the various types of data included in the control model created in response to each execution environment are a target of data tracking, it takes time for a calculation process, and there is a concern that it may be difficult to complete a data tracking communication within a calculation period. Since these pieces of data include, for example, data that is initialized and used each time the calculation begins and therefore does not require data tracking, it is also conceivable to shorten the time required for the data tracking communication by limiting the data as a target of data tracking. However, it is difficult to automatically extract data as a target of data tracking in this manner. For this reason, in the development environment using the MBD tool, only a single configuration supervisory control and data acquisition (SCADA) is used, and the reality is that it is not applied to a more complex multiplexed system.

On the other hand, in the current development environment of the control logic for the multiplexed system as a target, a region for holding an intermediate calculation value is provided for each arithmetic element (POL: problem-oriented language) included in the control logic, and data tracking for the intermediate calculation value between the operation side and the standby side handles the problem. In this case, although a data size of the data tracking as a target fluctuates according to the amount of control logic, the amount of control logic has an upper limit, and thus the data size of the data tracking also has an upper limit.

In the current development environment of the control logic for such a multiplexed system as a target, there is a function of describing a processing content of an arithmetic element in a general-purpose programming language in association with the control logic, but the number of program lines that can be described is limited. Therefore, it is not possible to describe a highly advanced control function model such as AI. In addition, since execution by an interpreter method takes time, a process may not be completed in the control period (meanwhile, it is difficult to compile and generate a binary in the execution environment because there are restrictions on the CPU processing calculation function, a capacity of the memory, and a storage). Therefore, in the current development environment of the multiplexed system, it is not possible to handle a highly advanced control function such as AI.

At least one embodiment of the present disclosure is made in view of the circumstances described above, and an object of the present disclosure is to provide a control program, a control system, and a control method for a multiplexed system, with which a highly advanced control function can be realized in a control logic for the multiplexed system as a target.

### Solution to Problem

In order to solve the above problems, according to at least one embodiment of the present disclosure, there is provided a control program for a multiplexed system including a control logic for controlling a multiplexed first execution environment and a multiplexed second execution environment, the control program causing a computer apparatus to execute: a step of calling a user-defined library function from at least one arithmetic element constituting the control logic; and a step of importing an intermediate calculation value of the user-defined library function on a standby side of the first execution environment or the second execution environment from an interface region in which the intermediate calculation value of the user-defined library function on an operation side of the first execution environment or the second execution environment is stored in advance.

In order to solve the above problems, according to at least one embodiment of the present disclosure, there is provided a control system for a multiplexed system including: an arithmetic unit configured to execute the control program according to at least one embodiment of the present disclosure.

In order to solve the above problems, according to at least one embodiment of the present disclosure, there is provided a control method for a multiplexed system including a control logic for controlling a multiplexed first execution environment and a multiplexed second execution environment, the control method including: a step of calling a user-defined library function from at least one arithmetic element constituting the control logic; a step of importing an intermediate calculation value of the user-defined library function on a standby side of the first execution environment or the second execution environment from an interface region in which the intermediate calculation value of the user-defined library function on an operation side of the first execution environment or the second execution environment is stored in advance; and a step of writing the intermediate calculation value of the user-defined library function on the operation side of the first execution environment or the second execution environment to the interface region.

### Advantageous Effects of Invention

According to at least one embodiment of the present disclosure, it is possible to provide a control program, a control system, and a control method for a multiplexed system, with which a highly advanced control function can be realized in a control logic for the multiplexed system as a target.

### BRIEF DESCRIPTION OF DRAWINGS

FIG. 1 is a schematic diagram illustrating a development process of a control program according to an embodiment.

FIG. 2 is a diagram illustrating an example of a control logic in FIG. 1.

FIG. 3 is an example of a user-defined library function that can be called by a function in FIG. 2.

FIG. 4 is a flowchart illustrating a control method executed by a control logic CL in FIG. 2.

FIG. 5 is a modification example in steps S22 and S23 in FIG. 4.

FIG. 6 is a diagram illustrating an example of a relationship between an execution process of a controller and the user-defined library function.

FIG. 7A is a schematic diagram illustrating a development process of a control logic using an MBD tool.

FIG. 7B is a schematic diagram illustrating a development process according to another reference technique for a multiplexed system as a target.

### DESCRIPTION OF EMBODIMENTS

Hereinafter, some embodiments of the present invention will be described with reference to the accompanying drawings. However, configurations described in the embodiments or illustrated in the drawings are not intended to limit the scope of the present invention, and are merely examples for description.

### Reference Technique

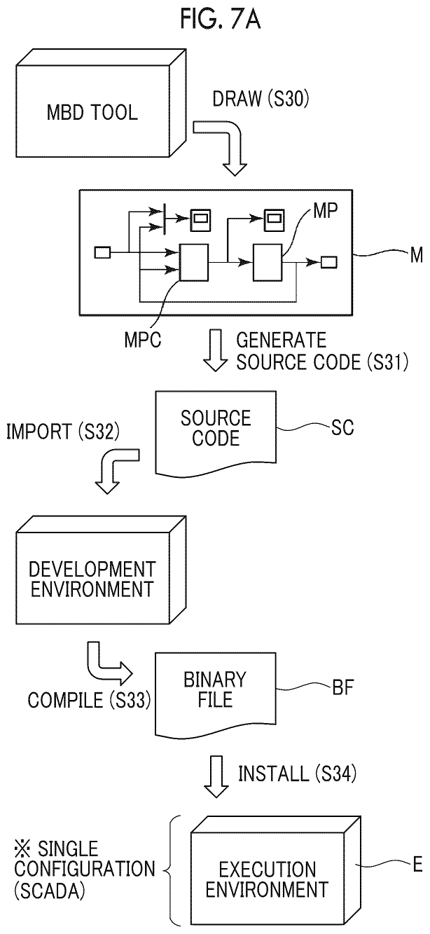

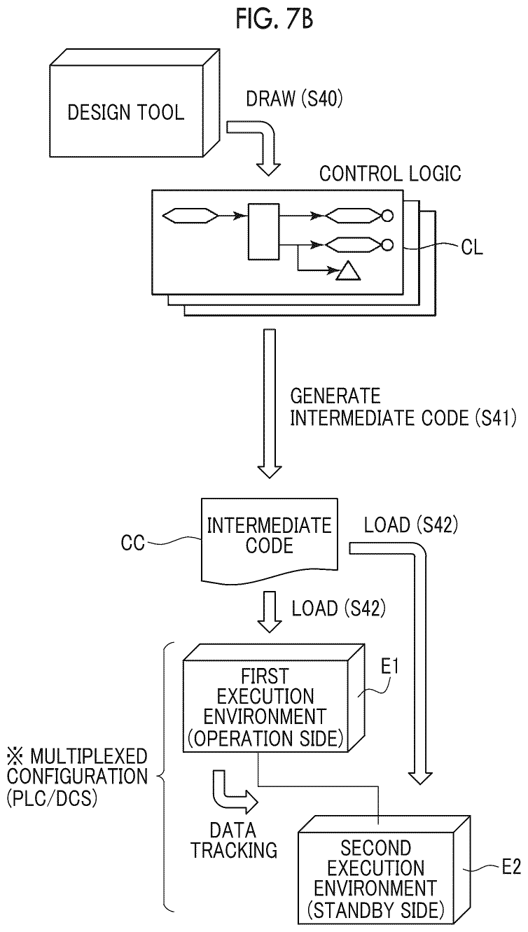

First, a reference technique on which the present invention is based will be described with reference to FIGS. 7A and 7B. FIG. 7A is a schematic diagram illustrating a development process of a control logic using an MBD tool. In FIG. 7A, a control logic to be installed in a single configuration supervisory control and data acquisition (SCADA) is a development target.

First, a control model M including a highly advanced control model such as AI is constructed by using the MBD tool (step S30). In the MBD tool, an operator can construct the control model M by combining components such as functions and operators. In FIG. 7A, as the control model M constructed by using the MBD tool, a control model including a model predictive control MPC and a plant model MP is simply illustrated.

Next, a source code SC corresponding to the control model M constructed in step S30 is automatically generated (step S31) by using a source code automatic generation function of the MBD tool. The MBD tool is provided with a function of describing (converting) the source code SC corresponding to the control model as a general-purpose programming language such as C language as a standard function or a plug-in function. In step S31, the source code SC corresponding to the control model M constructed in step S30 is generated by using the function of the MBD tool.

Next, the source code SC generated in step S31 is imported into a development environment (step S32), a binary file BF is created by compiling the source code SC (step S33), and the binary file BF is installed in an execution environment E (step S34). The execution environment E is a single control device (controller) such as supervisory control and data acquisition (SCADA).

The development process using the MBD tool described above with reference to FIG. 7A has the following problems. In a case where a multiplexed system with redundancy between two execution environments is a development target using the MBD tool, data tracking is performed between control models constructed to correspond to each of the two execution environments. In the source code automatically generated from the control model with data tracking in this manner, the data tracking can be treated as a global variable (including a static variable) common between the control models corresponding to the respective execution environments. However, when all the various types of data included in the control model corresponding to each execution environment are a target for data tracking, there is a concern that it takes time for the calculation process and that it is difficult to perform a data tracking communication within a calculation period. Since these pieces of data include, for example, data that is initialized and used each time the calculation begins and therefore does not require data tracking, it is also conceivable to shorten the time required for the data tracking communication by limiting the data as a target of data tracking. However, it is difficult to automatically extract data as a target of data tracking in this manner. For this reason, in the development process using the MBD tool, only the single configuration SCADA is used as the execution environment E, and it is difficult to apply to the multiplexed system.

Next, FIG. 7B is a schematic diagram illustrating a development process according to another reference technique for a multiplexed system as a target. In the reference technique illustrated in FIG. 7B, for example, two execution environments (first execution environment E1 and second execution environment E2) that are multiplexed with each other, such as a programmable logic controller (PLC) or a distributed control system (DCS), are targeted. In this type of multiplexed system, one of the two execution environments is set as an operation side and the other is set as a standby side, and when a problem occurs in the execution environment on the operation side, the execution environments on the operation side and the standby side are switched. In particular, when the execution environments of the operation side and the standby side are switched, a control state of the operation side is inherited (data tracking) by the standby side, so that a sudden change in the control state is prevented.

In the following description, unless otherwise specified, a case where the first execution environment E1 is the operation side and the second execution environment E2 is the standby side will be described, but the present disclosure is not limited thereto.

First, an operator draws a control logic CL by using a design tool (step S40). In step S40, the control logic CL is drawn by combining arithmetic elements. Information on the combination of the arithmetic elements in the drawn control logic CL is generated as an intermediate code CC (step S41). The intermediate code CC generated in step S41 is loaded into each of the multiplexed execution environments (the first execution environment E1 and the second execution environment E2) to be installed (step S42). In FIG. 7B, the intermediate code CC is loaded into each of the first execution environment E1 on the operation side and the second execution environment E2 on the standby side. As a result, various types of data necessary for multiplexing are transmitted and received between the first execution environment E1 and the second execution environment E2 into which the intermediate code CC is loaded, by data tracking.

In this manner, with reference to FIG. 7B, the development process of the multiplexed system has the following problems. In this type of development process, there is a function of describing a processing content of the arithmetic element in a general-purpose programming language in association with the control logic CL, but the number of program lines that can be described is limited. Therefore, it is not possible to describe a highly advanced control function model such as AI. In addition, since execution by an interpreter method takes time, a process may not be completed in the control period (meanwhile, it is difficult to compile and generate a binary in the execution environment because there are restrictions on the CPU processing calculation function, a capacity of the memory, and a storage). Therefore, in the current development environment of the multiplexed system, it is not possible to handle a highly advanced control function such as AL.

The problems of the development process according to the reference techniques illustrated in FIGS. 7A and 7B can be appropriately solved by a control program according to each embodiment to be described below.

### Embodiments

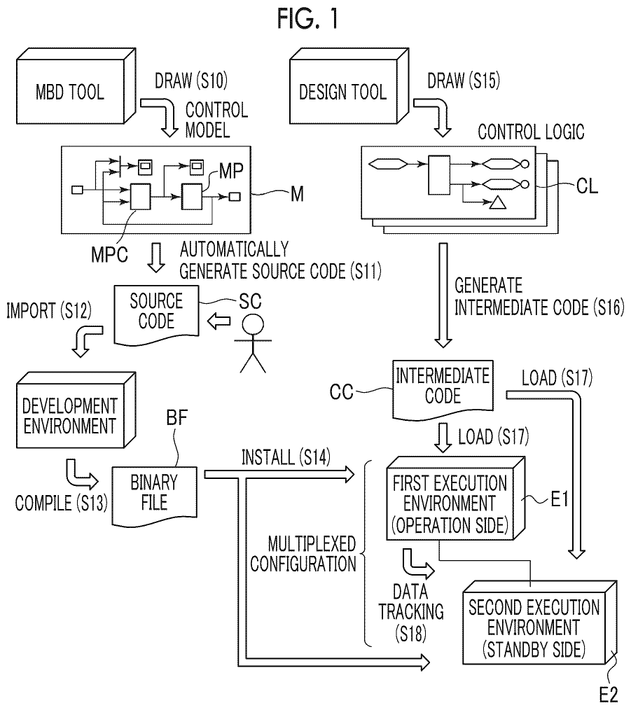

Next, a control program according to some embodiments will be specifically described. Here, FIG. 1 is a schematic diagram illustrating a development process of a control program according to one embodiment.

First, the control model M including a highly advanced control model such as AI is constructed by using the MBD tool (step S10). In the MBD tool, the control model M is constructed by combining components such as functions and operators by an operator. In FIG. 1, a control model M including the model predictive control MPC and the plant model MP, which are constructed by using the MBD tool, is simply illustrated.

Next, the source code SC corresponding to the control model M constructed in step S10 is automatically generated by using a source code automatic generation function of the MBD tool (step S11). The MBD tool is provided with a function of describing (converting) the source code SC corresponding to the control model as a general-purpose programming language such as C language as a standard function or a plug-in function. In step S11, the source code SC corresponding to the control model M constructed in step S10 is generated by using the function of the MBD tool. Next, the source code SC generated in step S11 is imported into a development environment (step S12), and the binary file BF is created by compiling the source code SC (step S13). The binary file BF created in step S13 is installed in each of the multiplexed first execution environment E1 and second execution environment E2 (step S14).

Meanwhile, the control logic CL is generated by drawing with a design tool (step S15). Then, the intermediate code CC of the control logic CL generated in step S15 is generated (step S16). The intermediate code CC is loaded into the first execution environment E1 and the second execution environment E2 (step S17), and thus data tracking between the first execution environment E1 and the second execution environment E2 is realized (step S18).

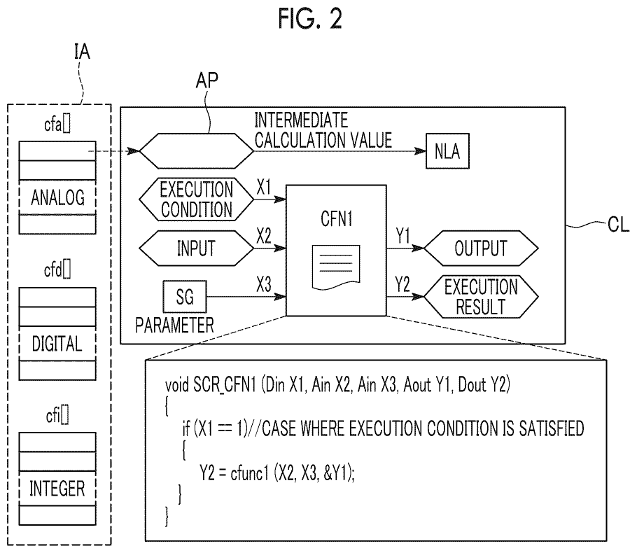

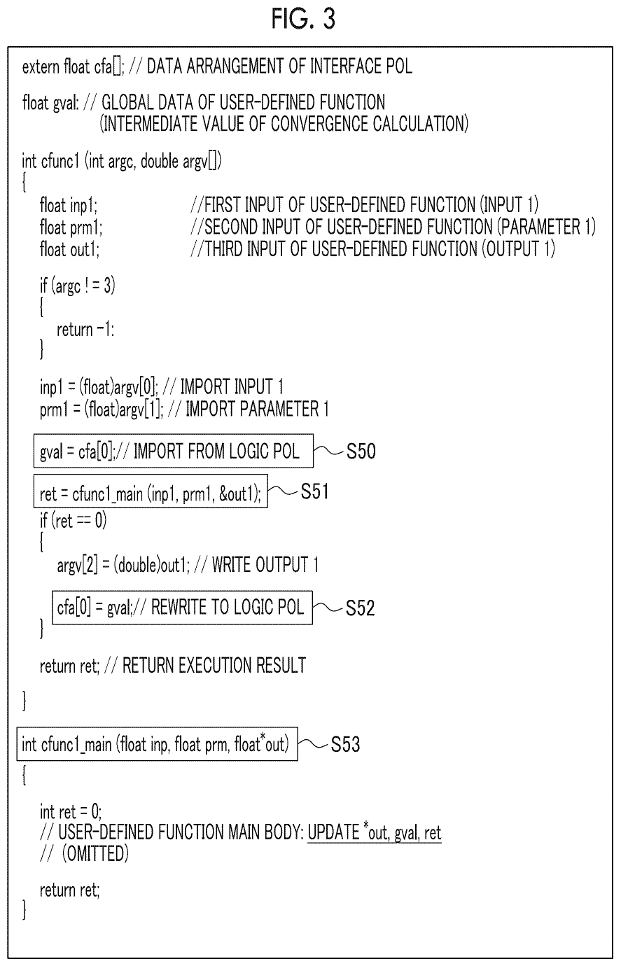

Here, FIG. 2 is a diagram illustrating an example of the control logic CL in FIG. 1, and FIG. 3 is an example of a user-defined library function cfunc1 that can be called by a function CFN1 in FIG. 2.

In FIG. 2, as an example of the control logic CL, a configuration centered on the function CFN1 is illustrated. The function CFN1 is constructed such that each of an execution condition X1, input data X2, and an input parameter X3 is input, and each of output data Y1 and an execution result Y2 is output from the function CFN1. In addition, the control logic CL includes an interface region IA in which data (data tracking target data) as a target of data tracking is stored, among various types of data handled by the function CFN1, and an intermediate calculation value acquisition unit AP for acquiring an intermediate calculation value from the interface region IA.

The interface region IA can store analog data, digital data, and integer data handled by the function CFN1 according to each data type. The intermediate calculation value acquisition unit AP can acquire the data stored in the interface region IA. Specifically, in the first execution environment E1 which is the operation side, an intermediate calculation value (latest intermediate calculation value) obtained by a calculation process of the function CFN1 is appropriately written to the interface region IA and is stored. On the other hand, in the second execution environment E2 which is the standby side, the intermediate calculation value stored in the interface region IA is imported, so that a control state corresponding to the first execution environment E1 which is the operation side can be reproduced.

In addition, in FIG. 2, the function CFN1 is described in a general-purpose programming language in association with the control logic CL. In this example, the function CFN1 is defined by using the variable X1 that is Din indicating a digital input type, the variables X2 and X3 that are Ain indicating an analog input type, the variable Y1 that is Aout indicating an analog output type, and the variable Y2 that is Dout indicating a digital output type. Specifically, when X1==1 is satisfied as an execution condition, Y2=cfunc1(X2, X3, &Y1) is executed. The function cfunc1 is a user-defined library function having the variables X2 and X3 as arguments and the variable Y1 as a return value, and is called from the function CENI which is an arithmetic element (POL) of the control logic CL. In this manner, in the present embodiment, the user-defined library function cfunc1 is configured to be called from the function CFN1, which is an arithmetic element constituting the control logic CL.

The arguments of the user-defined library function cfunc1 called by the function CFN1 are only an example, and the arrangement and number thereof can be appropriately defined by a user.

FIG. 3 illustrates an example of a specific content of the user-defined library function cfunc1 in FIG. 2. In the user-defined library function cfunc1, a variable inp1 is defined as a first input (input 1), a variable prm1 is defined as a second input (parameter 1), and a variable out1 is defined as a third input (output 1). The user-defined library function cfunc1 includes a portion (step S51) of calling a sub function cfunc1_main (step S53) in which a variable inp and a variable prm are defined as arguments and a variable out is defined as an argument indicating a storage location (address) of a calculation execution result, by using inp1 designated as a first argument, prm1 designated as a second argument, and &out1 designated as a third argument. In addition, a return value of the sub function cfunc1_main is stored in a variable ret (step S51, and Y2 in FIG. 2).

Note that “int” indicates a signed integer type, “float” indicates a single precision floating-point type, and “double” indicates a double precision floating-point type.

In the user-defined library function cfunc1, the sub function cfunc1 main is executed, so that the execution result is stored in the variable out1 for storing (Y1 in FIG. 2). Meanwhile, a calculation intermediate value (an intermediate calculation value cfa[0] of the user-defined library function cfunc1) is stored in a global variable gval and is written to the interface region IA for storing data tracking target data (step S52). The intermediate calculation value cfa[0] written as the interface region IA is data-tracked by being acquired by an intermediate calculation value acquisition unit AP in FIG. 2, in the second execution environment E2 on the standby side. Therefore, a control state of the first execution environment E1 on the operation side can be reproduced in the second execution environment E2 on the standby side.

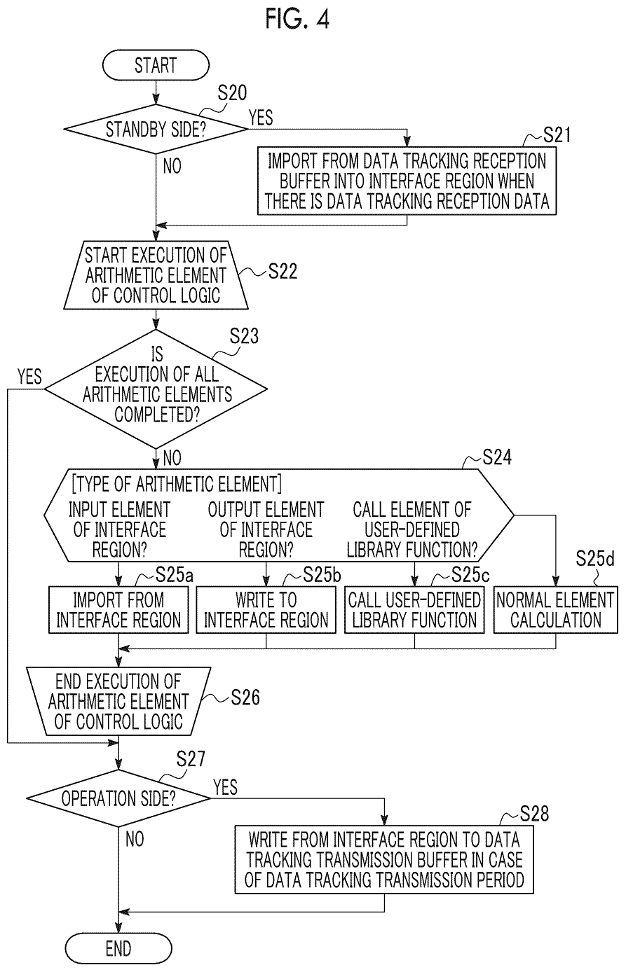

FIG. 4 is a flowchart illustrating a control method executed by the control logic CL in FIG. 2. In this control method, first, it is determined whether or not an execution environment (first execution environment E1 or second execution environment E2) as a control target is on the standby side (step S20). In a case where the execution environment is the standby side (YES in step S20), when there is data tracking reception data, the data tracking reception data is imported into the interface region IA from a data tracking reception buffer (step S21). Thereafter, or in a case where the execution environment is not the standby side (NO in step S20), execution of an arithmetic element of the control logic CL is started (step S22).

When the control logic CL is executed, it is determined whether or not the execution of all the arithmetic elements included in the control logic CL is completed (step S23). In a case where the execution of all the arithmetic elements is not completed (NO in step S23), the process is divided as follows according to a type of arithmetic element to be executed (step S24). When the arithmetic element to be executed is an input element of the interface region IA, an import process is performed from the interface region IA (step S25a). In addition, when the arithmetic element to be executed is an output element of the interface region IA, a write process is performed to the interface region IA (step S25b). In addition, when the arithmetic element to be executed is a call element of the user-defined library function cfunc1, a call process of the user-defined library function cfunc1 is performed (step S25c). In addition, when the arithmetic element to be executed is another element, a normal element calculation process is performed (step S25d). In this manner, when the process corresponding to the type of each arithmetic element is completed for all elements (YES in step S23), the execution of the arithmetic element of the control logic CL is ended (step S26).

Next, it is determined whether or not the execution environment is the operation side (step S27), In a case where the execution environment is the operation side (YES in step S27), in a case of a data tracking transmission period, writing is performed from the interface region IA to a data tracking transmission buffer (step S28), Thereafter, or in a case where the execution environment is not the operation side (NO in step S27), a series of control methods is ended.

When the control logic CL is executed in this manner, the user-defined library function cfunc1 is called in the process. For example, in a case where the second execution environment E2 is the standby side, in the second execution environment E2, an intermediate calculation value of the user-defined library function cfunc1 is acquired by being imported from the interface region IA. Strictly speaking, the intermediate calculation value is also imported from the interface region IA to the first execution environment E1 which is the operation side, but the intermediate calculation value imported to the first execution environment E1 which is the operation side is the previous value of the result calculated by the first execution environment E1. The intermediate calculation value is a recent previous value in the first execution environment E1 that is the operation side, and is stored in the interface region IA in advance. As a result, the control state of the first execution environment E1 on the operation side can be reproduced in the second execution environment E2 on the standby side. Next, in the first execution environment E1 on the operation side, the intermediate calculation value of the user-defined library function cfunc1 is written to the interface region IA. Strictly speaking, the intermediate calculation value is also written to the interface region IA in the second execution environment E2 on the standby side, but is overwritten by data tracking from the first execution environment E1 on the operation side. At this time, the intermediate calculation value in the first execution environment E1 on the operation side is stored in the interface region IA, and thus can be acquired as the intermediate calculation value on the standby side in the next and subsequent times.

A method for transmitting the tracking data from the execution environment on the operation side to the execution environment on the standby side is not limited.

In this manner, in the control logic CL, the user-defined library function cfunc1 is configured to be callable from at least some of the arithmetic elements (for example, POL). Therefore, by changing the user-defined library function cfunc1 included in the control logic CL, it is possible to provide the highly advanced control calculation function without changing the basic configuration of the entire control logic such as embedded software of the PLC/DCS. In the user-defined library function cfunc1, the intermediate calculation value in the first execution environment E1 on the operation side of the multiplexed system is stored in advance in the interface region IA, so that in the second execution environment E2 on the standby side, the intermediate calculation value can be imported from the interface region IA, and the multiplexing control with the data tracking that can be realized by the highly advanced control calculation function can be realized. Meanwhile, the intermediate calculation value of the user-defined library function cfunc1 in the first execution environment E1 on the operation side is written to the interface region IA. In this manner, the intermediate calculation value of the user-defined library function cfunc1 written to the interface region IA is imported to the user-defined library function cfunc1 in the second execution environment E2 on the standby side, so that data tracking between the two execution environments is realized.

In addition, the global variable as a data tracking target is logically defined in the user-defined library function cfunc1. Therefore, it is possible to clearly narrow down the data as a data tracking target among the respective pieces of data included in the control logic CL, and it is possible to suppress an increase in tracking data communication. As a result, it is possible to effectively prevent a situation in which the redundancy configuration becomes unrecoverable due to the data tracking communication not being completed within the specified time when the execution environment E2 on the standby side is started.

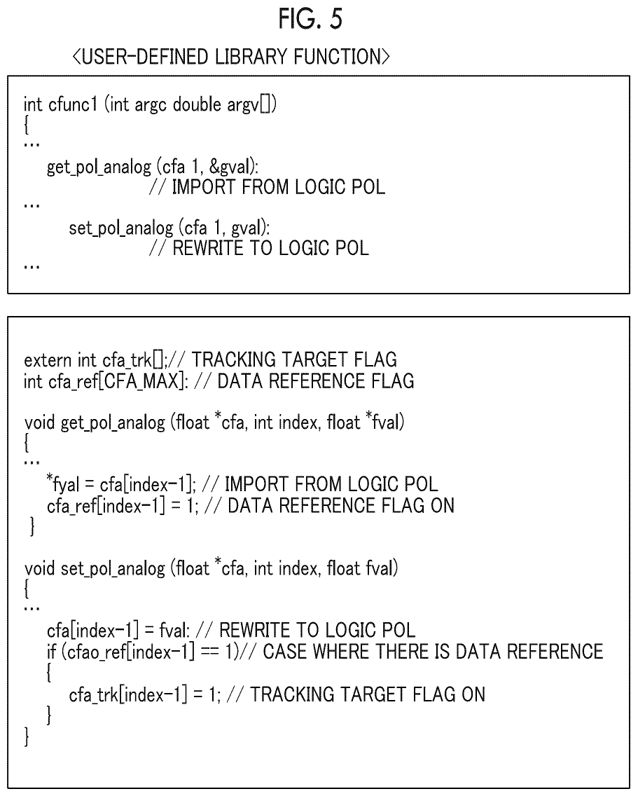

FIG. 5 is a modification example in steps S22 and S23 in FIG. 4. In this modification example, it is possible to designate a variable as a data tracking target, in the user-defined library function cfunc1. In FIG. 5, the variable gval is designated as a data tracking target, the variable gval, which is an intermediate calculation value of the control logic CL in the first execution environment E1 on the operation side, is written to the interface region IA, and the variable gval stored in the interface region IA can be imported into the second execution environment E2 on the standby side.

In this manner, whether or not each piece of data exchanged between the control logic CL and the user-defined library function cfunc1 is a data tracking target is automatically assigned within the user-defined library function cfunc1 described in a general-purpose programming language, instead of describing the arithmetic elements (POL) as input elements of the logic. Therefore, it is possible to effectively avoid the omission of the description of the logic for the data tracking target by an operator, as compared with a case where the operator designates data as the data tracking target.

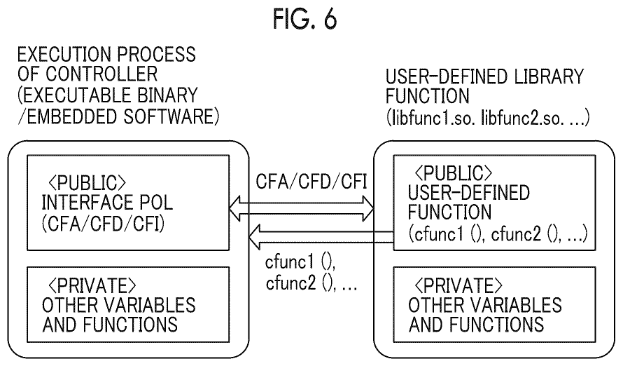

As illustrated in FIG. 6, by using a linker option, a scope of a variable symbol may be limited such that only the arithmetic element (POL) of the interface region IA between an object of the user-defined library function cfunc1 and a calculation object of the control logic CL is allowed to be read and written. As an example of the linker option that can be designated to be published in such a shared library, there is an LD version script of an open source gcc compiler. On the other hand, the scope of the function symbol may be limited such that only the user-defined library function cfunc1 allows the function call to the object of the user-defined library function from the user-defined library function cfunc1.

Therefore, when creating a user-defined script by automatically generating a source code described in the C language, which is a general-purpose programming language, from a highly advanced control model such as model predictive control or AI described in an MBD tool such as MATLAB or Simulink, the source code may accidentally overlap with variable symbols or function symbols of existing embedded software of the PLC/DCS. Therefore, it is possible to effectively avoid a situation in which a compilation error occurs or an irrelevant variable interferes with the source code, thereby causing a software bug to be mixed in.

As described above, according to each of the embodiments described above, it is possible to provide a control program, a control system, and a control method for a multiplexed system, with which a highly advanced control function can be realized in a control logic for the multiplexed system as a target.

In addition, it is possible to replace the components in the embodiments described above with well-known components as appropriate within the scope which does not depart from the gist of the present disclosure, and the embodiments described above may be combined as appropriate.

The contents described in each embodiment described above are understood as follows, for example.
(1) According to one aspect, there is provided a control program for a multiplexed system including a control logic for controlling a multiplexed first execution environment and a multiplexed second execution environment, the control program causing a computer apparatus to execute:
a step of calling a user-defined library function from at least one arithmetic element constituting the control logic; and
a step of importing an intermediate calculation value of the user-defined library function on a standby side of the first execution environment or the second execution environment from an interface region in which the intermediate calculation value of the user-defined library function on an operation side of the first execution environment or the second execution environment is stored in advance.

With the aspect (1) described above, the user-defined library function is configured to be callable from at least some of the arithmetic elements (for example, POL) constituting the control logic. Therefore, by changing the user-defined library function included in the control logic, it is possible to provide the highly advanced control calculation function without changing the basic configuration of the entire control logic such as embedded software of the PLC/DCS. In the user-defined library function, the intermediate calculation value in the execution environment on the operation side of the multiplexed system is stored in advance in the interface region, so that in the execution environment on the standby side, the intermediate calculation value can be imported from the interface region, and the multiplexing control with data tracking that can be realized by the highly advanced control calculation function can be realized.
(2) In another aspect, the aspect (1) described above further includes: a step of writing the intermediate calculation value of the user-defined library function on at least the operation side of the first execution environment or the second execution environment to the interface region.

With the aspect (2) described above, the intermediate calculation value of the user-defined library function in the execution environment on the operation side is written to at least the interface region. In this manner, the intermediate calculation value of the user-defined library function written to the interface region is imported to the user-defined library function in the execution environment on the standby side, so that data tracking between the two execution environments can be realized.
(3) In still another aspect, in the aspect (1) or (2) described above, the intermediate calculation value is data tracking target data between the first execution environment and the second execution environment.

With the aspect (3) described above, by using the intermediate calculation value of the user-defined library function as the data tracking target data, it is possible to clearly narrow down which variable among various global variables is to be the data tracking target in the control logic. Therefore, it is possible to suppress an unnecessary increase in data tracking target data. As a result, when the execution environment on the standby side of the multiplexed system is started, it is possible to effectively prevent the multiplexed configuration from becoming irrecoverable due to the fact that the data tracking communication is not completed within a prescribed time.

A method for transmitting the tracking data from the execution environment on the operation side to the execution environment on the standby side is not limited.
(4) In still another aspect, in the aspect (3) described above, the user-defined library function specifies the data tracking target data among a plurality of global variables included in the user-defined library function.

With the aspect (4) described above, the data tracking target data is specified in the user-defined library function. Therefore, it is possible to automatically assign which data is to be a data tracking target by a program instead of describing the data tracking target as an arithmetic element (for example, POL) which is a basic configuration of the control logic.
(5) In still another aspect, in any one of the aspects (1) to (4) described above, the user-defined library function is described in a general-purpose programming language.

With the aspect (5) described above, the user-defined library function called by the arithmetic element constituting the control logic can be appropriately described by using the general-purpose programming language.
(6) According to one aspect, there is provided a control system for a multiplexed system including:
an arithmetic unit configured to execute the control program according to any one of aspects (1) to (5).

With the aspect (6) described above, by executing the control program described above with the arithmetic unit, it is possible to realize a control system capable of performing multiplexing control with data tracking that can be realized by the highly advanced control calculation function.
(7) According to one aspect, there is provided a control method for a multiplexed system including a control logic for controlling a multiplexed first execution environment and a multiplexed second execution environment, the control method including:
a step of calling a user-defined library function from at least one arithmetic element constituting the control logic;
a step of importing an intermediate calculation value of the user-defined library function on a standby side of the first execution environment or the second execution environment from an interface region in which the intermediate calculation value of the user-defined library function on an operation side of the first execution environment or the second execution environment is stored in advance, and
a step of writing the intermediate calculation value of the user-defined library function on the operation side of the first execution environment or the second execution environment to the interface region.

With the aspect (7) described above, the user-defined library function is configured to be callable from at least some of the arithmetic elements (for example, POL) constituting the control logic. Therefore, by changing the user-defined library function included in the control logic, it is possible to provide the highly advanced control calculation function without changing the basic configuration of the entire control logic such as embedded software of the PLC/DCS. In the user-defined library function, the intermediate calculation value in the execution environment on the operation side of the multiplexed system is stored in advance in the interface region, so that in the execution environment on the standby side, the intermediate calculation value can be imported from the interface region, and the multiplexing control with data tracking that can be realized by the highly advanced control calculation function can be realized.

### REFERENCE SIGNS LIST

M: control model
CC: intermediate code
CL: control logic
SC: source code
BF: binary file
IA: interface region
AP: intermediate calculation value acquisition unit
E1: first execution environment
E2: second execution environment

1. A control program for a multiplexed system including a control logic for controlling a multiplexed first execution environment and a multiplexed second execution environment, the control program causing a computer apparatus to execute:
a step of calling a user-defined library function from at least one arithmetic element constituting the control logic; and
a step of importing an intermediate calculation value of the user-defined library function on a standby side of the first execution environment or the second execution environment from an interface region in which the intermediate calculation value of the user-defined library function on an operation side of the first execution environment or the second execution environment is stored in advance.

2. The control program for a multiplexed system according to claim 1, further comprising:
a step of writing the intermediate calculation value of the user-defined library function on at least the operation side of the first execution environment or the second execution environment to the interface region.

3. The control program for a multiplexed system according to claim 1,
wherein the intermediate calculation value is data tracking target data between the first execution environment and the second execution environment.

4. The control program for a multiplexed system according to claim 3,
wherein the user-defined library function specifies the data tracking target data among a plurality of global variables included in the user-defined library function.

5. The control program for a multiplexed system according to claim 1,
wherein the user-defined library function is described in a general-purpose programming language.

6. A control system for a multiplexed system comprising:
an arithmetic unit configured to execute the control program according to claim 1.

7. A control method for a multiplexed system including a control logic for controlling a multiplexed first execution environment and a multiplexed second execution environment, the control method comprising:
a step of calling a user-defined library function from at least one arithmetic element constituting the control logic; and
a step of importing an intermediate calculation value of the user-defined library function on a standby side of the first execution environment or the second execution environment from an interface region in which the intermediate calculation value of the user-defined library function on an operation side of the first execution environment or the second execution environment is stored in advance.
